(19) United States
(12) Patent Application Publication
(10) Pub. No.: US 2020/0242672 A1
(43) Pub. Date: Jul. 30, 2020

(54) DRESS MANAGEMENT SYSTEM AND METHOD OF USE

(71) Applicant: Blair Tynes, Arlington, TX (US)

(72) Inventor: Blair Tynes, Arlington, TX (US)

(21) Appl. No.: 16/688,533

(22) Filed: Nov. 19, 2019

Related U.S. Application Data
(60) Provisional application No. 62/769,349, filed on Nov. 19, 2018.

(51) Int. Cl. G06Q 30/06; A41D 1/22

(52) U.S. Cl. CPC G06Q 30/0603; A41D 1/22; G06Q 30/0633; G06Q 30/0621

(57) ABSTRACT

A dress management system enables the use and reuse of attire by multiple users. The system acquires used dresses and categorizes them and presents them for use. The dresses can be located by their style or color. The dress could be exchanged or purchased for use.

### BACKGROUND

### 1. Field of the Invention

The present invention relates generally to clothing systems, and more specifically, to a dress management system for controlling the location and use of formal attire for special occasions.

### 2. Description of Related Art

Clothing systems are well known in the art and are effective means to cover a person's body for protective, decorative, expressive or other ends. For example, FIG. 1 depicts a conventional formal dress process 101 beginning with the announcement of a special event 103, establishing color or style requirements 105 for the event, finding and purchasing a dress 107 for the event, wearing the dress 109 to the event, and storing the dress 111 after the event. The dress remains in a closet, box or other storage method and is seldom used again. Occasionally a dress will be worn again 113 if another event meets the criteria or if the dress is suitable for normal use, however, this is an exception and not the general practice.

One of the problems commonly associated with process 101 is its limited efficiency. For example, the effort to locate and purchase the dress is considerable and while the event merits the effort after the event the dress is generally not used again, causing waste and clutter where it is stored.

Accordingly, although great strides have been made in the area of formal dress processes, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common formal dress process;

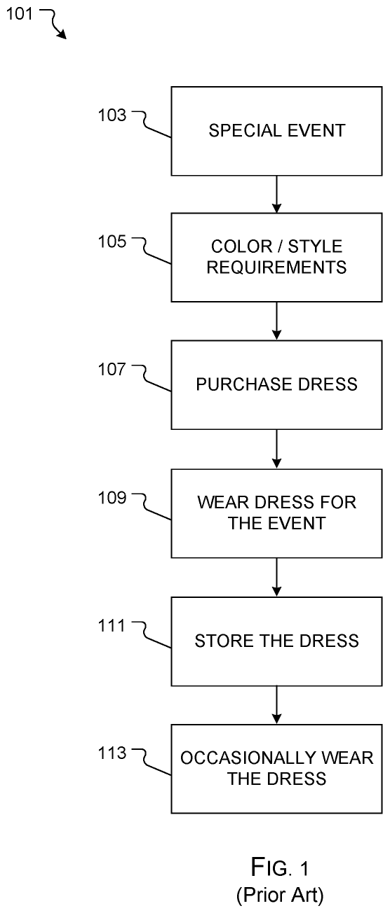

FIG. 2 is a flowchart of a dress management system in accordance with a preferred embodiment of the present application;

FIG. 3 is a diagram of the profile of the system of FIG. 2;

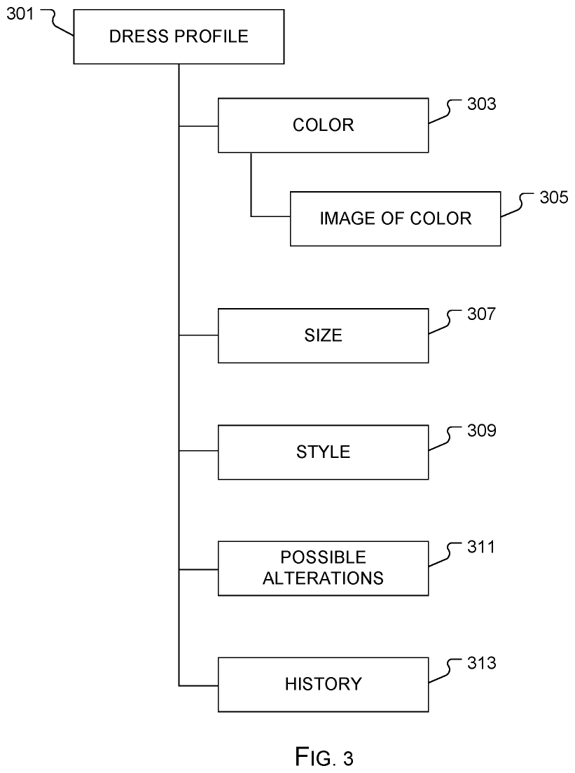

FIG. 4 is a flowchart of an alternative embodiment of the system of FIG. 2; and

FIG. 5 is a diagram of a dress locating system.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional formal dress processes. Specifically, the invention of the present application enables the rapid location of suitable dresses and the reuse of dress. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

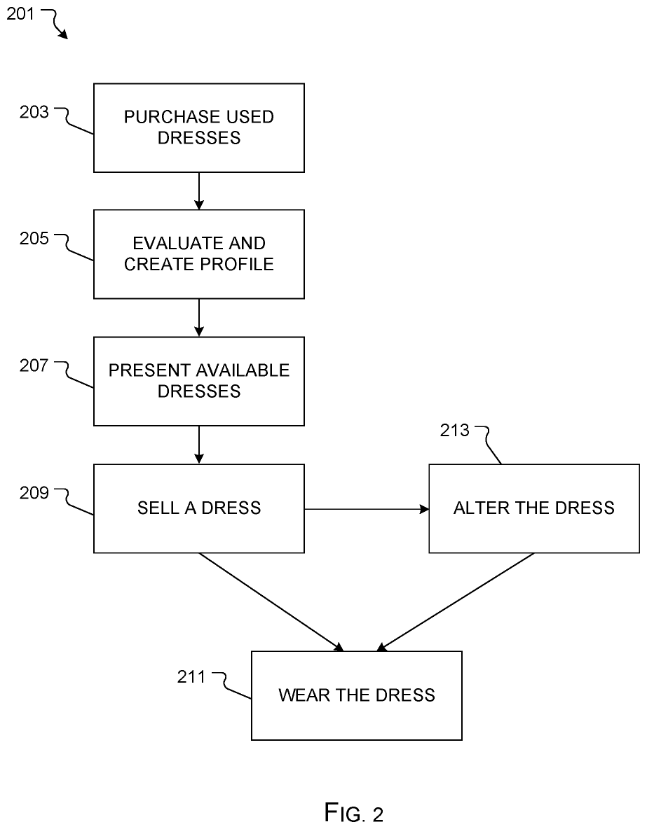

Referring now to the drawings wherein like reference characters identify corresponding or similar elements throughout the several views, FIG. 2 depicts a flowchart of a dress management system in accordance with a preferred embodiment of the present application. It will be appreciated that system 201 overcomes one or more of the above-listed problems commonly associated with conventional formal dress processes.

In the contemplated embodiment, system 201 includes purchasing used dresses 203, evaluating the dresses and creating a profile for each 205, presenting the available dresses to clients 207, selling a dress 209 and wearing the dress 211. After the dress is sold 209 altering the dress 213 if requested by the client.

It should be appreciated that one of the unique features believed characteristic of the present application is that dresses are reused and quickly located via their profile.

It is contemplated that each dress will have a profile 301. It is contemplated that each profile 301 includes data relevant to the type of dress. Examples of data include the color 303 of the dress, this could be defined by words, RGB codes or an image of the color 305, the size 307, style 307, possible alterations 311 or the history 313. These examples are given to demonstrate the contemplated process and are not intended to limit the scope of the system 201 or the profile 301 of each dress.

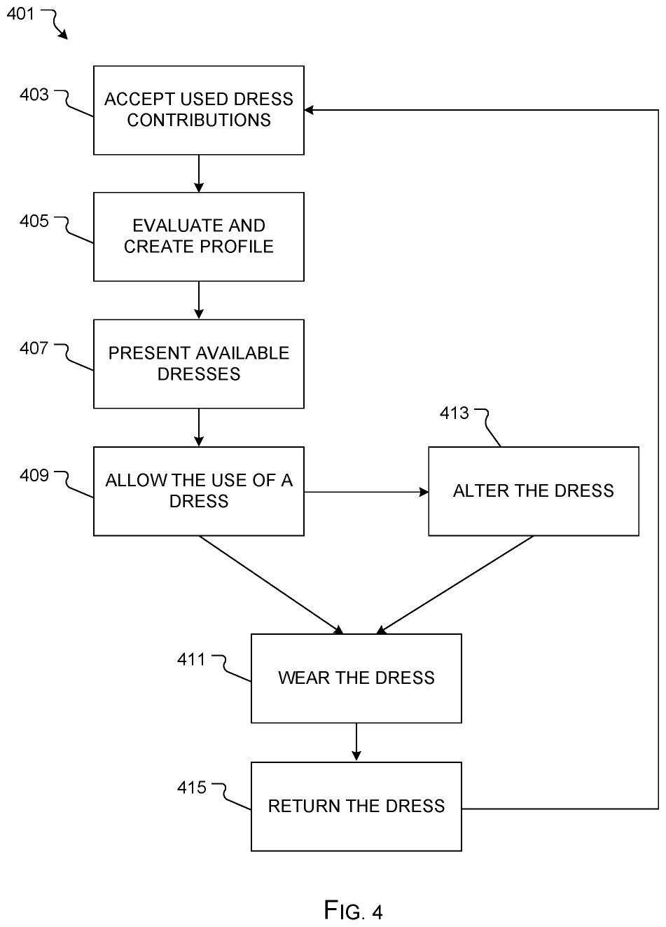

An alternative embodiment of system 201 is depicted by FIG. 4. Embodiment 401 establishes a cooperative dress outlet by accepting dresses 403 from members, evaluating the dresses and creating a profile for each 405, presenting the available dresses 407 to the members, allowing us of the dress 409, altering the dress if requested 413, wearing the dress 411 and returning the dress 415.

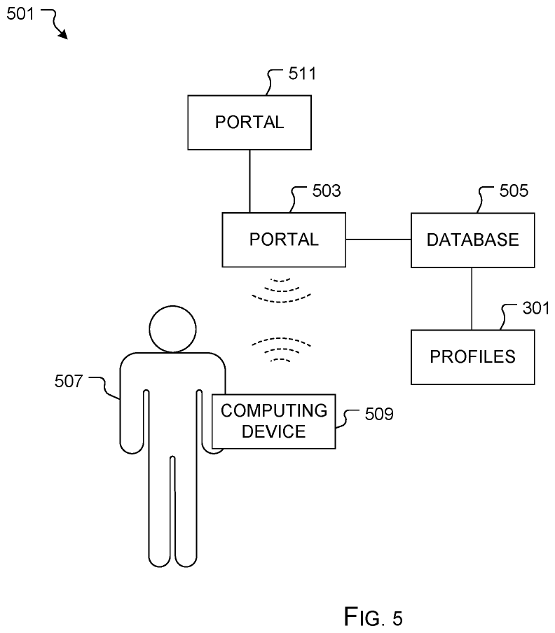

Referring now to FIG. 5 a system of locating a dress is depicted. System 501 includes a portal 503 in electronic communication with a database 505 where the profiles 301 of the dress are stored. A user 507 access the portal 503 via a computing device 509 and enters data relevant to the dress they desire, the portal 503 accepts the data and activates an algorithm 511 to provide recommendations on dresses that fit the data submitted by the user 507.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A dress management system comprising:
purchasing used dresses;
evaluating the dresses and creating a profile for each;
presenting the available dresses to clients;
selling a dress;
wearing the dress; and
altering the dress if requested by the client.
